(19) United States
(12) Patent Application Publication
(10) Pub. No.: US 2026/0128899 A1
(43) Pub. Date: May 7, 2026

(54) METHOD AND SYSTEM FOR SECURING PRIVILEGED ACCESS DATA VIA A PRIVILEGED ACCESS SECURITY SERVICE PLATFORM

(71) Applicant: JPMorgan Chase Bank, N.A., New York, NY (US)

(72) Inventors: Mohankumar RAJAGOPALAN, Plainview, NY (US); Amit Kumar MESHRAM, Romansville, PA (US)

(73) Assignee: JPMorgan Chase Bank, N.A., New York, NY (US)

(21) Appl. No.: 19/354,362

(22) Filed: Oct. 9, 2025

Related U.S. Application Data
(60) Provisional application No. 63/715,980, filed on Nov. 4, 2024.

(51) Int. Cl. H04L 9/32; H04L 9/08

(52) U.S. Cl. CPC H04L 9/3228; H04L 9/0877

(57) ABSTRACT

A method and system for securing privileged access data via a privileged access security service (PASS) platform may be provided. The method may include obtaining authentication data, providing a web-based UI portal to access a PASS platform upon ascertaining that user credentials are valid, and inputting digital case data into the web-based UI portal. The PASS platform may include an incident management and tracking system and an entitlement control management system. The method may include performing dual operations on the digital case data and generating an ADFS digital security token and a digital functional identifier (FID), and calling an API based on the ADFS digital security token and the digital FID. The method may also include testing the API internally via an API gateway endpoint and cloud APIs without exposing the ADFS digital security token to the user, generating a response based on the testing, and displaying the response.

### CROSS-REFERENCE TO RELATED APPLICATION

This application claims the benefit of U.S. Provisional Patent Application No. 63/715,980, filed November 4, 2024, which is hereby incorporated by reference in its entirety.

### FIELD OF DISCLOSURE

This technology generally relates to methods and systems for securing privileged access data via a privileged access security service platform.

### BACKGROUND INFORMATION

Engineering teams often need to generate active directory federation services (ADFS) tokens as part of a post-production deployment validation or production issues troubleshooting associated with secured data systems. While digital functional identifiers (FIDs) and password may be used, FIDs and passwords can result in privileged credential disclosure. For instance, knowledge of the FIDs and password by other parties besides the user and authorized parties, which can lead to unauthorized access to secured data systems with sensitive and confidential data or cause disruption of services.

Presently, while secured access services exist, a generic solution is not available that would enable the production validation of application program interfaces (APIs) for accessing the secured data systems without the need to expose the password, FIDs, or ADFS token which are required for API authentication. That is, to perform API authentication to access the secured data systems, users would need to expose either their password, digital FIDs, or ADFS token as part of the authentication process. This exposure can lead to stolen credentials, unauthorized access into the secured data systems by nefarious parties, etc.

Accordingly, there is a need for techniques to generate a secured service enabling secured access to a secured data system without the need to expose users’ authentication details.

### SUMMARY

The present disclosure, through one or more of its various aspects, embodiments, and/or specific features or sub-components, provides, inter alia, various systems, servers, devices, methods, media, programs, and platforms for securing privileged access data via a privileged access security service platform.

According to an aspect of the present disclosure, a method for securing privileged access data via a privileged access security service platform may be provided. The method may be implemented by at least one processor. The method may include: obtaining user credentials from a user; providing a web-based user interface (UI) portal to access a privileged access security service (PASS) platform upon ascertaining that the user credentials are valid, wherein the PASS platform comprises an integration of an incident management and tracking system and an entitlement control management system; inputting digital case data into the web-based UI portal; performing dual operations on the inputted digital case data, the dual operations comprising a first set of operations via the incident management and tracking system and a second set of operations via the entitlement control management system; generating an active directory federation services (ADFS) digital security token and a digital functional identifier (FID) based on an affirmative result of the dual operations; performing a software call function to call an application program interface (API) based on the ADFS digital security token and the digital FID; testing the API internally via an API gateway endpoint and cloud APIs without exposing the ADFS digital security token to the user; generating a response from the API based on the testing; and displaying the response via the web-based UI portal to the user.

The ascertaining that the user credentials are valid may include performing an authentication of the user credentials based on single sign-on (SSO) authentication.

The inputting of the digital case data may include inputting incident log data, user identifier data, application data, the user’s credentials, a uniform resource identifier (URI) endpoint data, and a case reason into the web-based UI portal.

The first set of operations via the incident management and tracking system may include: determining whether an incident report from the inputted digital case data is in a correct status state; generating the ADFS digital security token and the digital FID based on the affirmative result of the determining of whether the incident report is in the correct status state; generating an error message based on a negative result of the determining of whether the incident report is in the correct status state; and storing the error message in a database.

The determining of whether the incident report is in the correct status state may include determining whether the incident report is not more than a predetermined number of days old.

The second set of operations via the entitlement control management system may include: determining whether user identifier data from the inputted digital case data denotes that the user is in a group with correct entitlement access to access the PASS platform; generating the ADFS digital security token and the digital FID based on the affirmative result of the determining of whether the user identifier data denotes that the user is in the group with the correct entitlement access; generating an error message based on a negative result of the determining of whether the user identifier data denotes that the user is in the group with the correct entitlement access; and storing the error message in a database.

The method may further include: storing actions of the user in a database that establishes an audit trail of the actions of the user; and providing the stored actions of the user to the web-based UI portal for utilization in accessing the PASS platform.

The digital FID may be generated when an application is accessed. The digital FID may be valid for a predetermined amount of time.

The ADFS digital security token may be generated based on a computer network authentication protocol that utilizes symmetric key cryptography and a key distribution center concept.

According to another embodiment, a computing apparatus for securing privileged access data via a privileged access security service platform is provided. The computing apparatus includes a processor; a memory; and a communication interface coupled to each of the processor and the memory. The processor may be configured to: obtain user credentials from a user; provide a web-based user interface (UI) portal to access a privileged access security service (PASS) platform upon ascertaining that the user credentials are valid, wherein the PASS platform comprises an integration of an incident management and tracking system and an entitlement control management system; input digital case data into the web-based UI portal; perform dual operations on the inputted digital case data, the dual operations comprising a first set of operations via the incident management and tracking system and a second set of operations via the entitlement control management system; generate an active directory federation services (ADFS) digital security token and a digital functional identifier (FID) based on an affirmative result of the dual operations; perform a software call function to call an application program interface (API) based on the ADFS digital security token and the digital FID; test the API internally via an API gateway endpoint and cloud APIs without exposing the ADFS digital security token to the user; generate a response from the API based on the testing; and display the response via the web-based UI portal to the user.

The processor may be further configured to ascertain that the user credentials are valid by performing an authentication of the user credentials based on single sign-on (SSO) authentication.

The processor may be further configured to performing the inputting of the digital case data by inputting incident log data, user identifier data, application data, the user’s credentials, a uniform resource identifier (URI) endpoint data, and a case reason into the web-based UI portal.

The first set of operations via the incident management and tracking system may include: determining whether an incident report from the inputted digital case data is in a correct status state; generating the ADFS digital security token and the digital FID based on the affirmative result of the determining of whether the incident report is in the correct status state; generating an error message based on a negative result of the determining of whether the incident report is in the correct status state; and storing the error message in a database.

The determining of whether the incident report is in the correct status state comprises determining whether the incident report is not more than a predetermined number of days old.

The second set of operations via the entitlement control management system may include: determining whether user identifier data from the inputted digital case data denotes that the user is in a group with correct entitlement access to access the PASS platform; generating the ADFS digital security token and the digital FID based on the affirmative result of the determining of whether the user identifier data denotes that the user is in the group with the correct entitlement access; generating an error message based on a negative result of the determining of whether the user identifier data denotes that the user is in the group with the correct entitlement access; and storing the error message in a database.

The processor may be further configured to: store actions of the user in a database that establishes an audit trail of the actions of the user; and provide the stored actions of the user to the web-based UI portal for utilization in accessing the PASS platform.

The digital FID may be generated when an application is accessed. The digital FID may be valid for a predetermined amount of time.

The ADFS digital security token may be generated based on a computer network authentication protocol that utilizes symmetric key cryptography and a key distribution center concept.

According to yet another embodiment, a non-transitory computer readable storage medium storing instructions for securing privileged access data via a privileged access security service platform is provided. The storage medium includes a set of executable code which, when executed by a processor, causes the processor to: obtain user credentials from a user; provide a web-based user interface (UI) portal to access a privileged access security service (PASS) platform upon ascertaining that the user credentials are valid, wherein the PASS platform comprises an integration of an incident management and tracking system and an entitlement control management system; input digital case data into the web-based UI portal; perform dual operations on the inputted digital case data, the dual operations comprising a first set of operations via the incident management and tracking system and a second set of operations via the entitlement control management system; generate an active directory federation services (ADFS) digital security token and a digital functional identifier (FID) based on an affirmative result of the dual operations; perform a software call function to call an application program interface (API) based on the ADFS digital security token and the digital FID; test the API internally via an API gateway endpoint and cloud APIs without exposing the ADFS digital security token to the user; generate a response from the API based on the test; and display the response via the web-based UI portal to the user.

When executed, the executable code may further cause the processor to ascertain that the user credentials are valid by performing an authentication of the user credentials based on single sign-on (SSO) authentication.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a system diagram of a computer system.

FIG. 2 illustrates a network diagram of a network environment.

FIG. 3 illustrates a diagram of a system environment for securing privileged access data via a privileged access security service platform according to an embodiment.

FIG. 4 illustrates a flowchart of a process diagram according to an embodiment for securing privileged access data via a PASS platform according to an embodiment.

FIG. 5 illustrates a framework for securing privileged access data via a PASS platform according to an embodiment.

FIG. 6 illustrates an example flowchart of a process for securing privileged access data via a PASS platform according to an embodiment.

### DETAILED DESCRIPTION

Engineering teams often need to generate active directory federation services (ADFS) tokens as part of a post-production deployment validation or production issues troubleshooting associated with secured data systems. While digital functional identifiers (FIDs) and password may be used, FIDs and passwords can result in privileged credential disclosure. For instance, knowledge of the FIDs and password by other parties besides the user and authorized parties, which can lead to unauthorized access to secured data systems with sensitive and confidential data or cause disruption of services.

Presently, while secured access services exist, a generic solution is not available that would enable the production validation of application program interfaces (APIs) for accessing the secured data systems without the need to expose the password, FIDs, or ADFS token which are required for API authentication. That is, to perform API authentication to access the secured data systems, users would need to expose either their password, FIDs, or ADFS token as part of the authentication process. This exposure can lead to stolen credentials, unauthorized access into the secured data systems by nefarious parties, etc.

The present application discloses securing privileged access data via a privileged access security service (PASS) platform, enabling more efficient and more secure and custom solution for protecting access to systems than traditional methods. The present application provides a technological improvement of the status quo because it enables a platform framework for using ADFS token for internal testing of the APIs in isolation from the user, i.e., without user intervention and exposure of the internal testing to the user. Additionally, the present application also prevents the exposure of the user’s password, FIDs, or ADFS token as part of the authentication process. The present application also provides a customized solution tailored to the needs of an enterprise or organization that integrates and leverages applications currently being utilized by enterprise or organization. Further details of the present application are provided below.

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

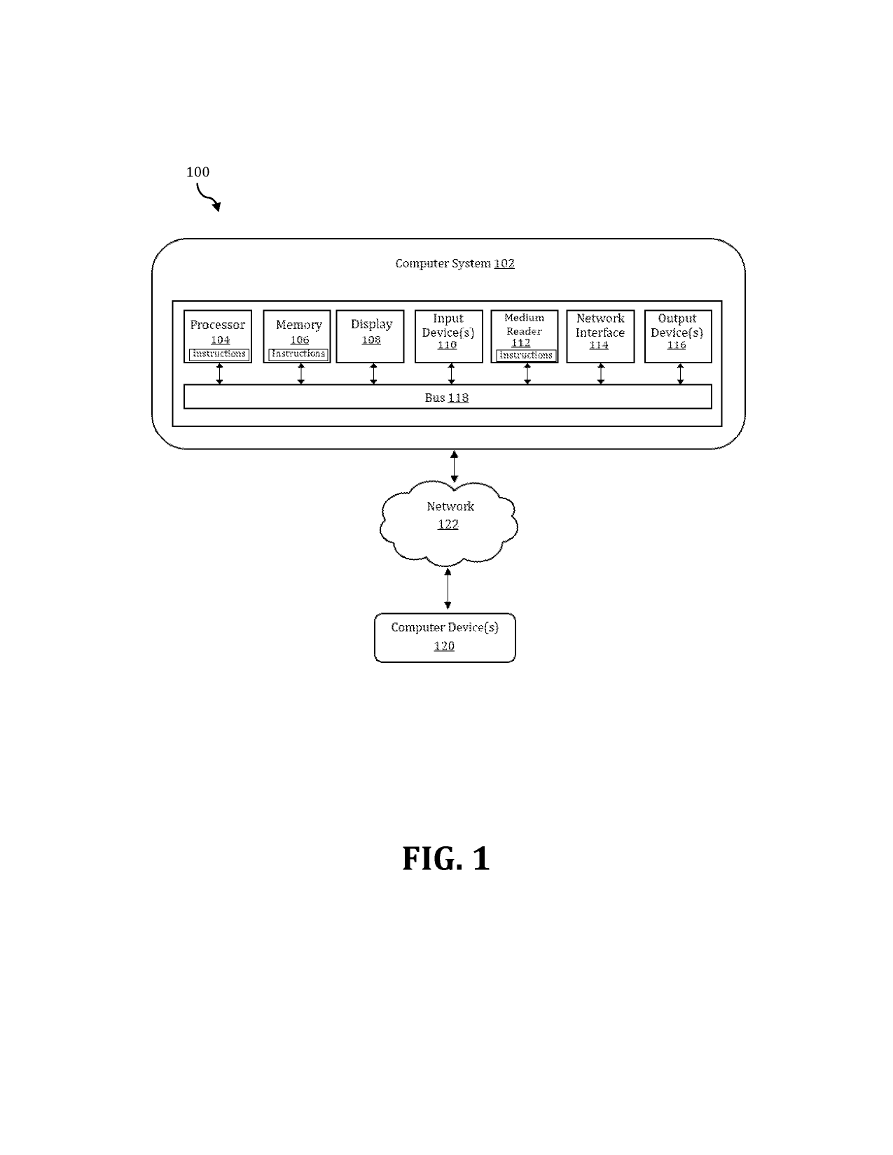

FIG. 1 illustrates a system 100 diagram of a computer system 102 for use in accordance with the embodiments described herein. The system 100 may be generally shown and may include a computer system 102, which may be generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 may be illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, digital optical disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but not limited to, a local area network, a wide area network, the Internet, a telephony network, a short-range network, or any other network commonly known and understood in the art. The short-range network may include, for example, short-range wireless technology standard used for exchanging data between fixed devices and mobile devices over short distances, low-power wireless ad-hoc mesh networks for linking together, infrared, near field communication, ultra-wideband, or any combination thereof. Those skilled in the art appreciate that additional networks 122 which are known and understood may additionally or alternatively be used and that the networks 122 are not limiting or exhaustive. Also, while the network 122 may be illustrated in FIG. 1 as a wireless network, those skilled in the art appreciate that the network 122 may also be a wired network.

The additional computer device 120 may be illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely examples of devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be examples and are not intended to be exhaustive and/or inclusive. Furthermore, the examples of the components listed above are also similarly not meant to be exhaustive and/or inclusive.

In accordance with various embodiments of the present disclosure, the methods described herein may be implemented using a hardware computer system that executes software programs. Further, in a non-limiting embodiment, implementations may include distributed processing, component/object distributed processing, and parallel processing. Virtual computer system processing may be constructed to implement one or more of the methods or functionalities as described herein, and a processor described herein may be used to support a virtual processing environment.

As described herein, various embodiments provide for securing privileged access data via a PASS platform.

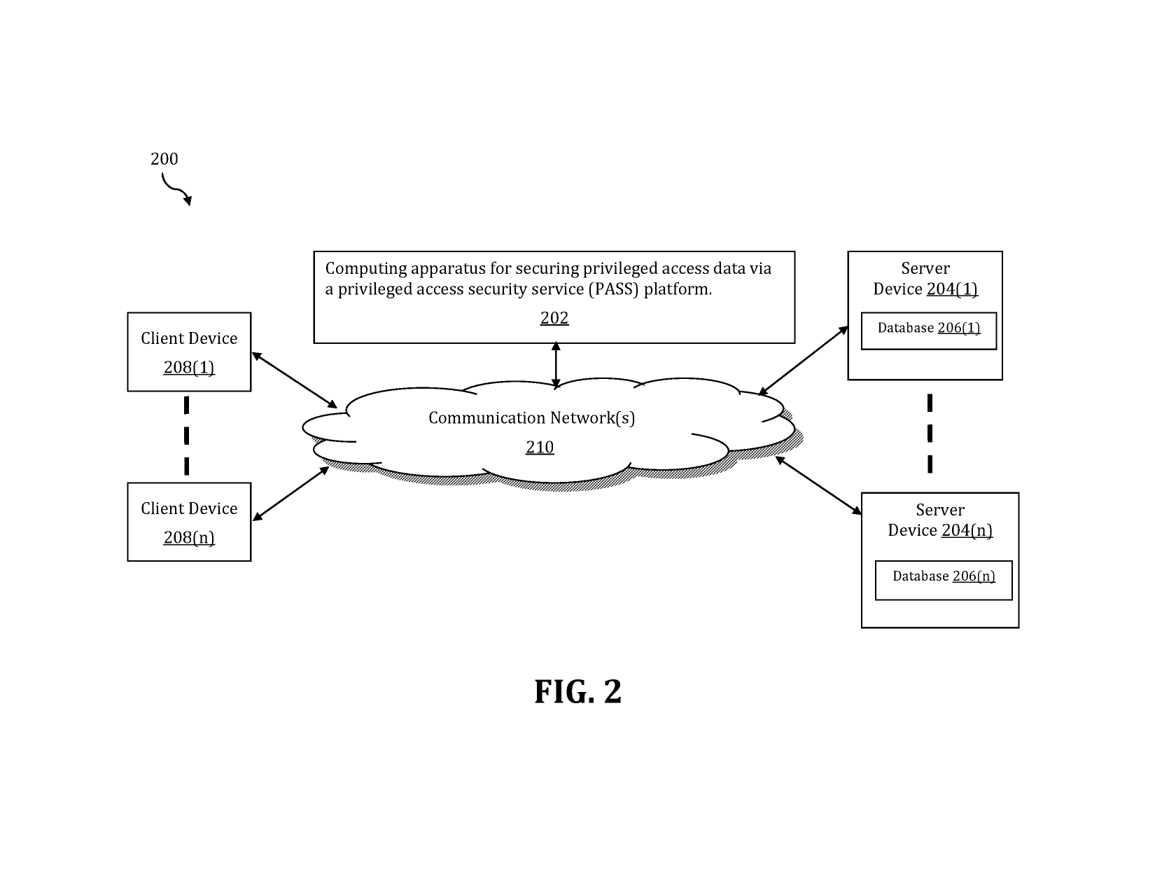

Referring to FIG. 2, a network diagram of a network environment 200 for securing privileged access data via a PASS platform may be illustrated. In an embodiment, the method may be executable on any networked computer platform, such as, for example, a personal computer (PC).

The method for securing privileged access data via the PASS platform may be implemented by a computing apparatus 202 that implements generating the PASS. The computing apparatus 202 may be the same or similar to the computer system 102 as described with respect to FIG. 1. The computing apparatus 202 may store one or more applications that may include executable instructions that, when executed by the computing apparatus 202, cause the computing apparatus 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s) may be located in virtual server(s) running in a cloud-based computing environment rather than being tied to one or more specific physical network computing devices. Also, the application(s) may be running in one or more virtual machines (VMs) executing on the computing apparatus 202. Additionally, in one or more embodiments of this technology, virtual machine(s) running on the computing apparatus 202 may be managed or supervised by a hypervisor.

In the network environment 200 of FIG. 2, the computing apparatus 202 may be coupled to a plurality of server devices 204(1)-204(n) that hosts a plurality of databases 206(1)-206(n), and also to a plurality of client devices 208(1)-208(n) via communication network(s) 210. A communication interface of the computing apparatus 202, such as the network interface 114 of the computer system 102 of FIG. 1, operatively couples and communicates between the computing apparatus 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used. The server devices 204(1)-204(n) and/or the client devices 208(1)-208(n) may provide different computing environments.

The communication network(s) 210 may be the same or similar to the network 122 as described with respect to FIG. 1, although the computing apparatus 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and computing apparatus that efficiently implement a method for securing privileged access data via a PASS platform.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, for example, tele-traffic in any suitable form (e.g., voice, modem, and the like), Public Switched Telephone Network (PSTNs), Ethernet-based Packet Data Networks (PDNs), combinations thereof, and the like.

The computing apparatus 202 may be a standalone device or integrated with one or more other devices or apparatuses, such as one or more of the server devices 204(1)-204(n), for example. In one particular example, the computing apparatus 202 may include or be hosted by one of the server devices 204(1)-204(n), and other arrangements are also possible. Moreover, one or more of the devices of the computing apparatus 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the computing apparatus 202 via the communication network(s) 210 according to the HTTP-based and/or script object notation protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store information.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that may interact with the computing apparatus 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an embodiment, at least one client device 208 may be a wireless mobile communication device, i.e., a smart phone.

The client devices 208(1)-208(n) may run interface applications, such as standard web browsers or standalone client applications, which may provide an interface to communicate with the computing apparatus 202 via the communication network(s) 210 in order to communicate user requests and information. The client devices 208(1)-208(n) may further include, among other features, a display device, such as a display screen or touchscreen, and/or an input device, such as a keyboard, for example.

Although the network environment 200 with the computing apparatus 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems described herein are for example purposes, as many variations of the specific hardware and software used to implement the examples are possible, as will be appreciated by those skilled in the relevant art(s).

One or more of the devices depicted in the network environment 200, such as the computing apparatus 202, the server devices 204(1)-204(n), or the client devices 208(1)-208(n), for example, may be configured to operate as a virtual instance on the same physical machine. In other words, one or more of the computing apparatus 202, the server devices 204(1)-204(n), or the client devices 208(1)-208(n) may operate on the same physical device rather than as separate devices communicating through communication network(s) 210. Additionally, there may be more or fewer computing apparatus 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only tele-traffic in any suitable form (e.g., voice and modem), wireless traffic networks, cellular traffic networks, Packet Data Networks (PDNs), the Internet, intranets, and combinations thereof.

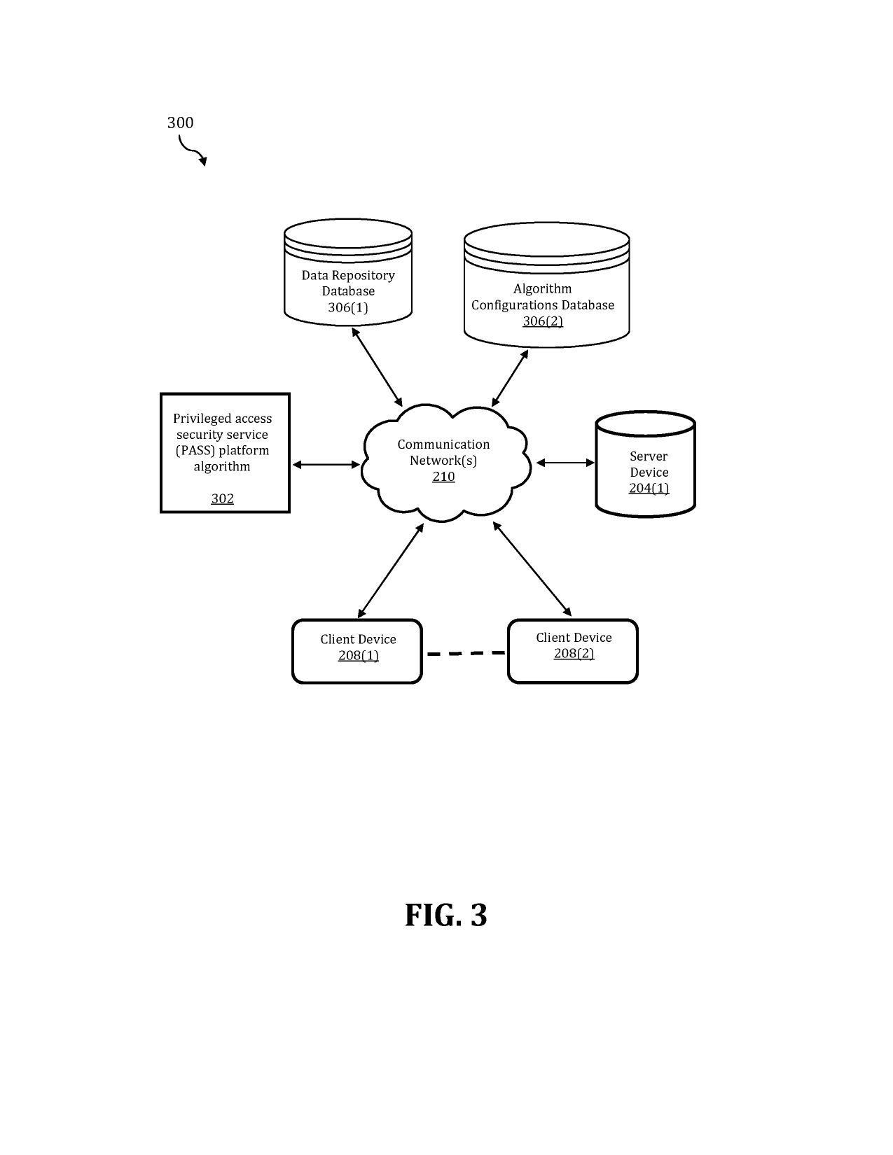

The computing apparatus 202 may be described and illustrated in FIG. 3 as may include a PASS platform algorithm 302, although it may include other rules, algorithms, policies, modules, databases, or applications, for example. As will be described below, the PASS platform algorithm 302 may be configured to implement a method for securing privileged access data via a privileged access security service (PASS) platform.

FIG. 3 illustrates a diagram of a system environment 300 for implementing a method for securing privileged access data via a PASS platform by utilizing the network environment of FIG. 2, which may be illustrated as being executed in FIG. 3. Specifically, a first client device 208(1) and a second client device 208(2) are illustrated as being in communication with computing apparatus 202. In this regard, the first client device 208(1) and the second client device 208(2) may be “clients” of the computing apparatus 202 and are described herein as such. Nevertheless, it is to be known and understood that the first client device 208(1) and/or the second client device 208(2) need not necessarily be “clients” of the computing apparatus 202, or any entity described in association therewith herein. Any additional or alternative relationship may exist between either or both of the first client device 208(1) and the second client device 208(2) and the computing apparatus 202, or no relationship may exist.

Further, computing apparatus 202 may be illustrated as being able to access a data repository database 306(1) and an algorithm configurations database 306(2). The PASS platform algorithm 302 may be configured to access these databases for securing privileged access data via the PASS platform.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an embodiment, either or both of the first client device 208(1) and the second client device 208(2) may communicate with the computing apparatus 202 via broadband or cellular communication. Of course, these embodiments are merely examples and are not limiting or exhaustive.

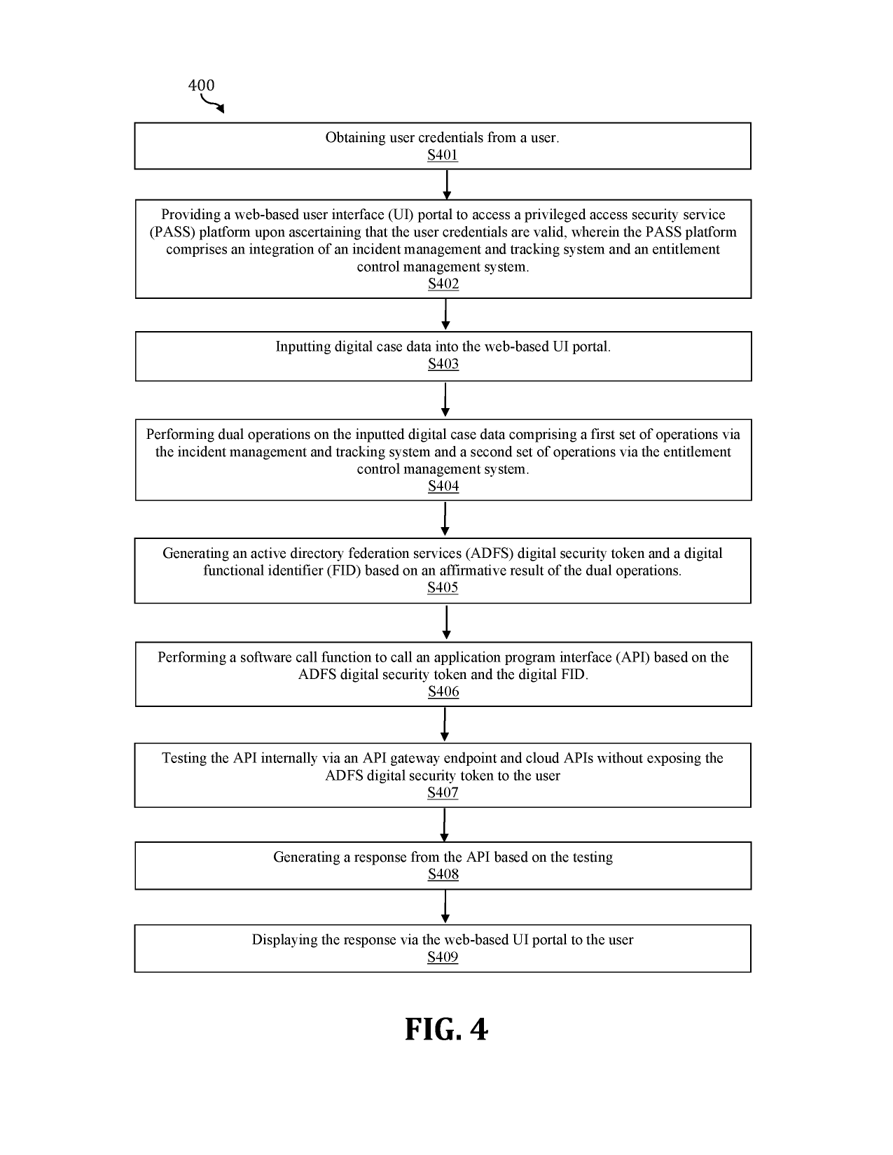

Upon being started, the PASS platform algorithm 302 may execute a process implementing a method for securing privileged access data via the PASS platform. A process for securing privileged access data via the PASS platform may be generally indicated at flowchart 400 in FIG. 4.

FIG. 4 illustrates a flowchart of a process diagram 400 of securing privileged access data via the PASS platform according to an embodiment. The process diagram 400 may be implemented by the system environment 300 of FIG. 3, a network environment 200 of FIG. 2, and the system 100 of FIG. 1.

At step S401 of the flowchart process 400, the computing apparatus 202 may obtain user credentials from a user. The user credentials may include, but are not limited to, the user’s name, password, username, employee identification number, etc.

At step S402 of the flowchart process 400, the computing apparatus 202 may provide a web-based user interface (UI) portal to access a privileged access security service (PASS) platform upon ascertaining that the user credentials are valid. The PASS platform may include an integration of an incident management and tracking system and an entitlement control management system. The ascertaining may include performing an authentication of the user credentials based on single sign-on (SSO) authentication. That is, the SSO authentication may be enable a user to access multiple applications using one set of login credentials.

At step S403 of the of the flowchart process 400, the computing apparatus 202 may input digital case data into the web-based UI portal. The inputting the digital case data into the web-based UI portal may include inputting incident log data, user identifier data, application data, the user’s credentials, a uniform resource identifier (URI) endpoint data, and a case reason into the web-based UI portal. The URI endpoint data may be related to an endpoint application. An example of a URI endpoint data for a financial institution may be financial account data of a client. The case reason may be a reason or issue related to a case, why the user needs to access this case, etc. A case may be an application, program, or software, etc. For instance, since different API has different parameters, a case reason may be an issue with a parameter of a certain API, an issue with the API overall, why the user needs access to this particular API, what the user needs to validate regarding this API, etc.

At step S404 of the of the flowchart process 400, the computing apparatus 202 may perform dual operations on the inputted digital case data that may include a first set of operations via the incident management and tracking system and a second set of operations via the entitlement control management system.

The first set of operations may be performed by the incident management and tracking system. The incident management and tracking system may perform the first set of operations by determining whether an incident report from the inputted digital case data is in a correct status state, and generating the ADFS digital security token and the digital FID based on the affirmative result of the determining. The incident management and tracking system may further perform the first set of operations by generating an error message based on a negative result of the determining and storing the error message in a database.

The second set of operations may be performed by the entitlement control management system. The entitlement control management system may perform the second set of operations by determining whether user identifier data from the inputted digital case data denotes that the user is in a group with correct entitlement access to access the PASS platform, and generating the ADFS digital security token and the digital FID based on the affirmative result of the determining. The entitlement control management system may further perform the second set of operations by generating an error message based on a negative result of the determining and store the error message in a database.

At step S405 of the of the flowchart process 400, the computing apparatus 202 may generate an active directory federation services (ADFS) digital security token and a digital functional identifier (FID) based on an affirmative result of the dual operations. The digital FID may be created in correlation with an application, wherein the digital FID may be generated when an application is accessed and may be valid for a predetermined amount of time. For example, several minutes, hours, days, etc. The ADFS digital security token may be generated by the PASS platform based on a computer network authentication protocol utilizing symmetric key cryptography and a key distribution center concept. That is, the ADFS digital security token by the PASS platform via KERBEROS®.

At step S406 of the of the flowchart process 400, the computing apparatus 202 may perform a software call function to call an application program interface (API) based on the ADFS digital security token and the digital FID.

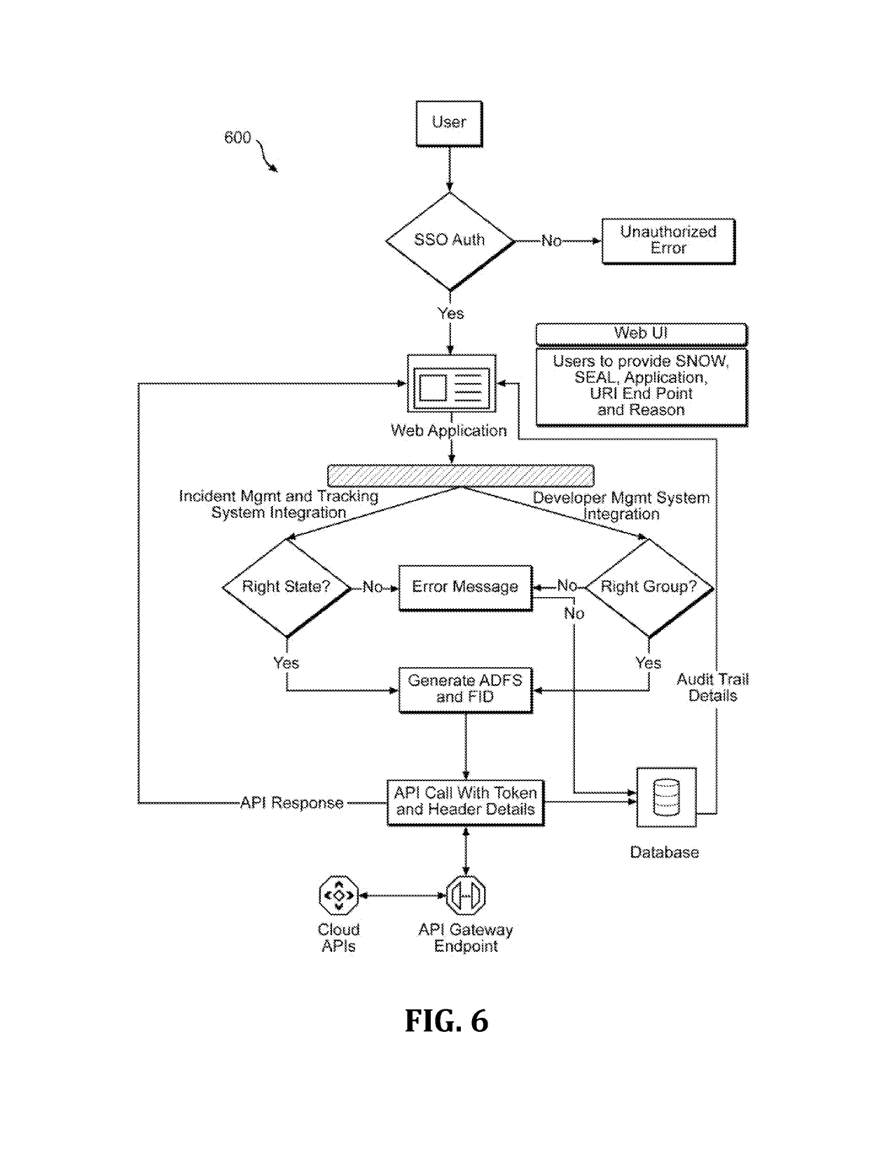

At step S407 of the of the flowchart process 400, the computing apparatus 202 may test the API internally via an API gateway endpoint and cloud APIs without exposing the ADFS digital security token to the user. This is shown in FIG. 6.

At step S408 of the of the flowchart process 400, the computing apparatus 202 may generate a response from the API based on the testing. The computer apparatus 202 may further store actions of the user in a database that establishes an audit trail of the actions of the user and provide the stored actions of the user to the web-based UI portal for utilization in accessing the PASS platform. This is shown in FIG. 6.

At step S409 of the of the flowchart process 400, the computing apparatus 202 may display the response via the web-based UI portal to the user.

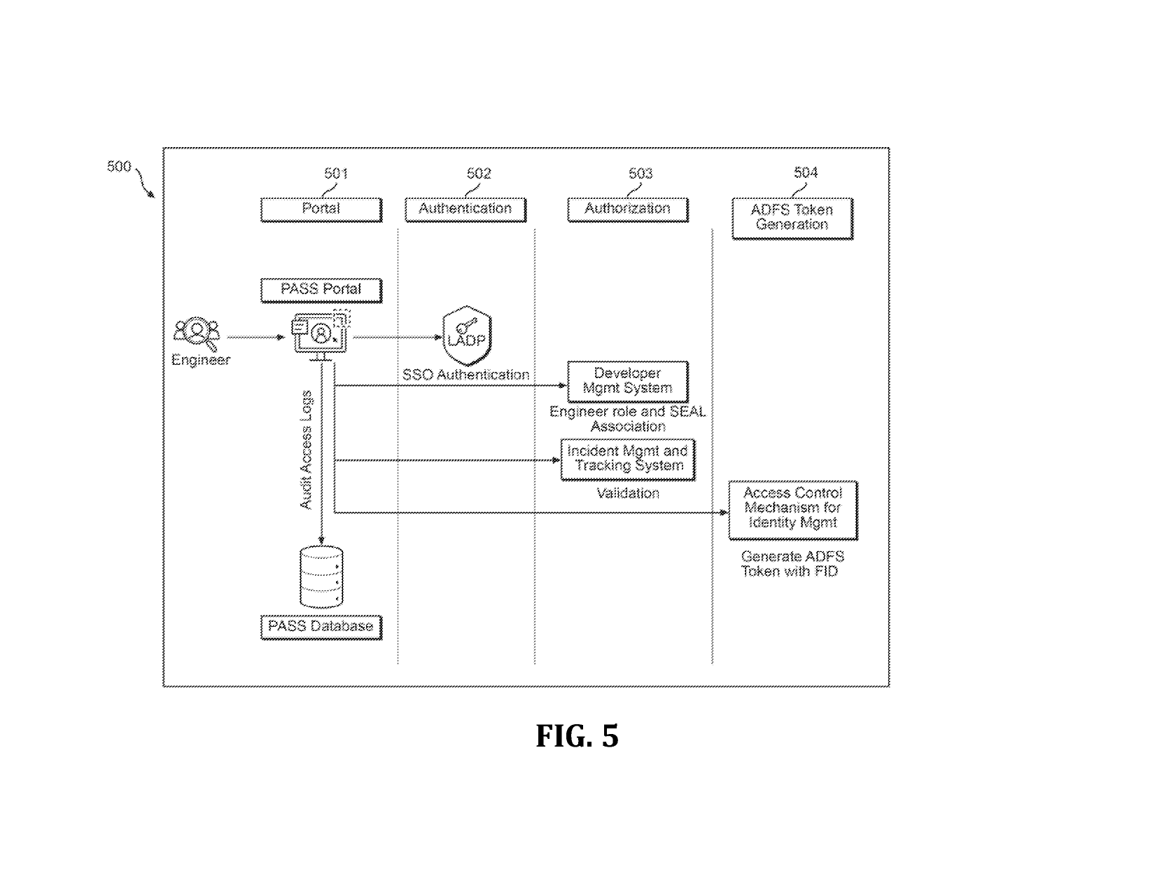

FIG. 5 illustrates a framework 500 for securing privileged access data via a PASS platform according to an embodiment as described in FIG. 4. The framework 500 may be a PASS platform framework. The portal 501 may be a web-based user interface (UI) portal. The portal 501 may also include a PASS portal and a PASS database (DB). A user, e.g., an engineer, may enter the user’s credentials into the PASS portal. The user’s credentials, as well as data regarding the user’s actions, may be stored in the PASS DB to enable an audit of access logs.

Continuing FIG. 5, the user’s credentials may be provided for authentication 502 based on a SSO authentication. The user’s credentials may also be provided for authorization 503. For authorization 503, the user’s credentials may be provided to a developer management system and an incident management tracking system as part of the framework 500. The user’s credential, such as a role of the user (e.g., that the user is an engineer), and a SEAL association may be provided to the developer management system. The developer management system may manage entitlements of a user, such as the user’s credential and SEAL association that entitle/authorize the user to access certain applications. The SEAL association may denote an internal identifier for a group of users, e.g., group of engineers, by mapping users (e.g., engineers) to an application. For example, a SEAL association may denote a certain group of engineers with authority to access a particular application.

Continuing with the authorization 503, the incident management tracking system may provide a control mechanism via tracking incident logs and providing validation of incident logs and incident data. For instance, the incident management tracking system may track an incident ticket as part of the incident log, wherein the incident ticket may be active for a limited time window, e.g., 7 days, but not more than a maximum time window, e.g., 30 days. The 7 days and 30 days are used as illustrative examples and does not denote a limitation or restriction to those dates. Any such dates as so desired may be utilized. The validation of the incident logs and incident data may be based on standards engineering and application libraries. The user may provide a case reason for the validation.

The user’s credentials may also be provided for ADFS token generation 504. The ADFS token generation 504 may be performed via an access control mechanism for identity management. The access control mechanism for identity management may generate ADFS tokens with FID.

FIG. 6 illustrates an example flowchart 600 of a process for securing privileged access data via a PASS platform according to an embodiment as described in FIGS. 4 and 5. The flowchart starts with a user providing the user’s credentials for SSO authentication. If the SSO authentication provides a negative result rejecting the user’s credentials, then there is an unauthorized error, and the user is not authorized to enter the web application. The web application may be a web-based user interface (UI) portal. The web application may then provide access to the PASS platform.

Continuing with the flowchart 600, if the SSO authentication provides a positive result, i.e., ascertaining that the user credentials are valid, then the user may access the web application, e.g., a web-based UI portal, enabling the user to access the PASS platform. The PASS platform may include an incident management and tracking system and an entitlement control management system, wherein each of these systems may be integrated with the PASS platform.

Digital case data may be inputted into the PASS platform through the web application. The digital case data may include incident log data, user identifier data, application data, the user credentials, a uniform resource identifier (URI) endpoint data, and a case reason into the web application.

Dual operations may be performed on the inputted digital case data that may include a first set of operations via the incident management and tracking system and a second set of operations via the entitlement control management system.

The first set of operations may be performed via the incident management and tracking system that may include determining whether an incident report from the inputted digital case data is in a correct status state (i.e., a right state). An example of a right state may be an active incident ticket (e.g., an incident ticket not more than a certain number of days old, such as not more than 7 days old). Based on an affirmative result of the correct status state determination, the ADFS digital security token and the digital FID may be generated. But upon a negative result of the correct status state determination, an error message may be generated instead. The error message may be stored in a database.

A second set of operations via the entitlement control management system may be performed that may include determining whether user identifier data from the inputted digital case data denotes that the user may be in a group with correct entitlement access to access the PASS platform. That is, user being in a right group authorized to access the PASS platform. Based on the affirmative result of the determination, the ADFS digital security token and the digital FID may be generated. But upon a negative result of the determination, an error message may be generated instead. The error message may be stored in the database.

Aside from the error messages, the database may also store the user’s actions to establish an audit trail of the actions performed by the user. Thus, enabling every user action to be uniquely tracked. The database may also provide the stored actions of the user to the web-based UI portal for utilization in accessing the PASS platform.

Continuing with the flowchart 600, a software call function may be performed to call an application program interface (API) based on the generated ADFS digital security token and the digital FID. The ADFS digital security token and the digital FID resulting from the dual operations as described above. Data regarding the calling of the API may also be transmitted to the database for storage.

Continuing with the flowchart 600, the API may be tested internally using an API gateway endpoint and cloud APIs without exposing the ADFS digital security token to the user. For instance, the testing internally may be done using primarily a “ready” function such that it would be isolated from the user’s view and prevents the user from intervening.

Upon a completion of the API’s internal testing, a response may be generated from the API based on the testing. This response may then be transmitted back to the web-based UI portal to the user for displaying of the response.

Although the invention has been described with reference to several embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting embodiment, the computer-readable medium may include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure may be considered to include any computer-readable medium or other equivalents and successor media, in which data or instructions may be stored.

Although the present application describes specific embodiments which may be implemented as computer programs or code segments in computer-readable media, it may be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for securing privileged access data via a privileged access security service platform, the method being implemented by at least one processor, the method comprising:
obtaining user credentials from a user;
providing a web-based user interface (UI) portal to access a privileged access security service (PASS) platform upon ascertaining that the user credentials are valid, wherein the PASS platform comprises an integration of an incident management and tracking system and an entitlement control management system;
inputting digital case data into the web-based UI portal;
performing dual operations on the inputted digital case data, the dual operations comprising a first set of operations via the incident management and tracking system and a second set of operations via the entitlement control management system;
generating an active directory federation services (ADFS) digital security token and a digital functional identifier (FID) based on an affirmative result of the dual operations;
performing a software call function to call an application program interface (API) based on the ADFS digital security token and the digital FID;
testing the API internally via an API gateway endpoint and cloud APIs without exposing the ADFS digital security token to the user;
generating a response from the API based on the testing; and
displaying the response via the web-based UI portal to the user.

2. The method of claim 1, wherein the ascertaining that the user credentials are valid comprises performing an authentication of the user credentials based on single sign-on (SSO) authentication.

3. The method of claim 1, wherein the inputting of the digital case data comprises inputting incident log data, user identifier data, application data, the user’s credentials, a uniform resource identifier (URI) endpoint data, and a case reason into the web-based UI portal.

4. The method of claim 1, wherein the first set of operations via the incident management and tracking system comprises:
determining whether an incident report from the inputted digital case data is in a correct status state;
generating the ADFS digital security token and the digital FID based on the affirmative result of the determining of whether the incident report is in the correct status state;
generating an error message based on a negative result of the determining of whether the incident report is in the correct status state; and
storing the error message in a database.

5. The method of claim 4, wherein the determining of whether the incident report is in the correct status state comprises determining whether the incident report is not more than a predetermined number of days old.

6. The method of claim 1, wherein the second set of operations via the entitlement control management system comprises:
determining whether user identifier data from the inputted digital case data denotes that the user is in a group with correct entitlement access to access the PASS platform;
generating the ADFS digital security token and the digital FID based on the affirmative result of the determining of whether the user identifier data denotes that the user is in the group with the correct entitlement access;
generating an error message based on a negative result of the determining of whether the user identifier data denotes that the user is in the group with the correct entitlement access; and
storing the error message in a database.

7. The method of claim 1, further comprising:
storing actions of the user in a database that establishes an audit trail of the actions of the user; and
providing the stored actions of the user to the web-based UI portal for utilization in accessing the PASS platform.

8. The method of claim 1, wherein the digital FID is generated when an application is accessed, and wherein the digital FID is valid for a predetermined amount of time.

9. The method of claim 1, wherein the ADFS digital security token is generated based on a computer network authentication protocol that utilizes symmetric key cryptography and a key distribution center concept.

10. A computing apparatus for securing privileged access data via a privileged access security service platform, the computing apparatus comprising:
a processor;
a memory; and
a communication interface coupled to each of the processor and the memory,
wherein the processor is configured to:
obtain user credentials from a user;
provide a web-based user interface (UI) portal to access a privileged access security service (PASS) platform upon ascertaining that the user credentials are valid, wherein the PASS platform comprises an integration of an incident management and tracking system and an entitlement control management system;
input digital case data into the web-based UI portal;
perform dual operations on the inputted digital case data, the dual operations comprising a first set of operations via the incident management and tracking system and a second set of operations via the entitlement control management system;
generate an active directory federation services (ADFS) digital security token and a digital functional identifier (FID) based on an affirmative result of the dual operations;
perform a software call function to call an application program interface (API) based on the ADFS digital security token and the digital FID;
test the API internally via an API gateway endpoint and cloud APIs without exposing the ADFS digital security token to the user;
generate a response from the API based on the testing; and
display the response via the web-based UI portal to the user.

11. The computing apparatus of claim 10, wherein the processor is further configured to ascertain that the user credentials are valid by performing an authentication of the user credentials based on single sign-on (SSO) authentication.

12. The computing apparatus of claim 10, wherein the processor is further configured to performing the inputting of the digital case data by inputting incident log data, user identifier data, application data, the user’s credentials, a uniform resource identifier (URI) endpoint data, and a case reason into the web-based UI portal.

13. The computing apparatus of claim 10, wherein the first set of operations via the incident management and tracking system comprises:
determining whether an incident report from the inputted digital case data is in a correct status state;
generating the ADFS digital security token and the digital FID based on the affirmative result of the determining of whether the incident report is in the correct status state;
generating an error message based on a negative result of the determining of whether the incident report is in the correct status state; and
storing the error message in a database.

14. The computing apparatus of claim 13, wherein the determining of whether the incident report is in the correct status state comprises determining whether the incident report is not more than a predetermined number of days old.

15. The computing apparatus of claim 10, wherein the second set of operations via the entitlement control management system comprises:
determining whether user identifier data from the inputted digital case data denotes that the user is in a group with correct entitlement access to access the PASS platform;
generating the ADFS digital security token and the digital FID based on the affirmative result of the determining of whether the user identifier data denotes that the user is in the group with the correct entitlement access;
generating an error message based on a negative result of the determining of whether the user identifier data denotes that the user is in the group with the correct entitlement access; and
storing the error message in a database.

16. The computing apparatus of claim 10, wherein the processor is further configured to:
store actions of the user in a database that establishes an audit trail of the actions of the user; and
provide the stored actions of the user to the web-based UI portal for utilization in accessing the PASS platform.

17. The computing apparatus of claim 10, wherein the digital FID is generated when an application is accessed, and wherein the digital FID is valid for a predetermined amount of time.

18. The computing apparatus of claim 10, wherein the ADFS digital security token is generated based on a computer network authentication protocol that utilizes symmetric key cryptography and a key distribution center concept.

19. A non-transitory computer readable storage medium storing instructions for securing privileged access data via a privileged access security service platform, the storage medium comprising executable code which, when executed by a processor, causes the processor to:
obtain user credentials from a user;
provide a web-based user interface (UI) portal to access a privileged access security service (PASS) platform upon ascertaining that the user credentials are valid, wherein the PASS platform comprises an integration of an incident management and tracking system and an entitlement control management system;
input digital case data into the web-based UI portal;
perform dual operations on the inputted digital case data, the dual operations comprising a first set of operations via the incident management and tracking system and a second set of operations via the entitlement control management system;
generate an active directory federation services (ADFS) digital security token and a digital functional identifier (FID) based on an affirmative result of the dual operations;
perform a software call function to call an application program interface (API) based on the ADFS digital security token and the digital FID;
test the API internally via an API gateway endpoint and cloud APIs without exposing the ADFS digital security token to the user;
generate a response from the API based on the test; and
display the response via the web-based UI portal to the user.

20. The storage medium of claim 19, wherein when executed, the executable code further causes the processor to ascertain that the user credentials are valid by performing an authentication of the user credentials based on single sign-on (SSO) authentication.
